(19) United States
(12) Patent Application Publication
(10) Pub. No.: US 2006/0110575 A1
(43) Pub. Date: May 25, 2006

(54) Slide element and method for production of said slide element

(75) Inventors: Stefan Rosiwal, Bamberg (DE); Martin Ruffer, Poppenricht (DE); Hans-Georg Jentsch, Erlangen (DE)

Correspondence Address: RANKIN, HILL, PORTER & CLARK LLP, 4080 ERIE STREET, WILLOUGHBY, OH, 44094-7836, US

(73) Assignee: DiaCCon GmbH, Furth (DE)

(21) Appl. No.: 10/512,346

(22) PCT Filed: Apr. 23, 2003
(86) PCT No.: PCT/EP03/04226

§ 371 Date: Dec. 15, 2004

(30) Foreign Application Priority Data
Apr. 24, 2002 (DE) 102 18 208.6

(51) Int. Cl. G11B 5/64

(52) U.S. Cl. 428/141

(57) ABSTRACT

The invention relates to a gliding element with a substrate and a diamond layer formed on a surface of the substrate with an average maximum roughness value Rz. To improve the dry running properties the invention suggests that the diamond layer has reproducible recesses for the collection of abrasion, wherein a depth of the recesses is greater than the average maximum roughness value Rz.

The invention relates to a gliding element as defined in the preamble of claim 1. Moreover it relates to a method of manufacturing the gliding element.

A gliding element of this type is known from U.S. Pat. No. 5,108,813 as well as from WO 00/26433. To reduce the friction coefficient and the abrasion of the diamond layer it is suggested that the gaps created between the diamond crystals be filled with a soft metal. In actual practice, however, it has been shown that the filling consisting of the soft metal wears off relatively quickly. This causes the gliding element to lose its anti-frictional properties.

From EP 0 529 327 A1 a fired ceramic product with a structured surface is known. To improve the tribological properties it is suggested to form the structuring in a regular arrangement of uniform depressions. Although the fired ceramic product exhibits good tribological properties, the resistance to abrasion is not sufficient for extreme loads.

From EP 0 617 207 B1 a bearing is known on which tribological stressed contact surfaces facing one another are provided with a diamond layer. Such a bearing does not have sufficient dry running and anti-frictional properties for certain applications.

From DE 197 16 330 A1 a method is known for the manufacture of a coating on a grinding tool. There it is suggested that the diamond layer be made particularly rough. Such a diamond layer is not suitable for the manufacture of tribologically stressed surfaces for sliding rings or bearings.

From EP 0 614 999 B1 a component of a bearing or a sealing arrangement is known on which a wear surface is formed from a layer made of polycrystalline diamond. The diamond layer is formed so that its tribologically stressed surface has a reduced resistance to wear. For this purpose the surface is formed from a soft nano-crystalline diamond layer which is located on a hard polycrystalline diamond layer. In actual practice such a diamond layer does not have adequate anti-frictional and dry running properties.

Especially in the area of highly stressed components, particularly with sliding bearings and sliding ring seals, improved anti-frictional and dry running properties are desired. Particularly during dry running, very high friction coefficients and/or friction coefficient fluctuations occur suddenly. Such friction coefficients and/or friction coefficient fluctuations also destroy gliding elements which are coated with a conventional diamond layer.

The object of the invention is to remove the disadvantages as defined in the state of technology. In particular a gliding element is to be specified which has improved anti-frictional and dry running properties. Furthermore a method is to be provided for the manufacture of such a gliding element.

This object is solved by the features of claims 1, 13 and 14. Useful embodiments result from the features of claims 2 to 12 and 15 to 28.

According to the invention it is provided that the diamond layer has reproducible recesses to hold abrasion wherein the depth of the recesses is greater than the average maximum roughness value Rz.

Surprisingly such a gliding element exhibits drastically improved anti-frictional and dry running properties. According to the current state of knowledge this is thought to be due to abrasion consisting of nano-crystalline diamond and graphite is formed particularly during dry running. With conventional diamond layers the abrasion collects on the surface in the depressions between the diamond crystals. As soon as all depressions are filled, a drastic increase of the friction coefficient is observed. This destroys the diamond layer. By supplying recesses according to the invention in the diamond layer the depth of which recesses is greater than the average maximum roughness value Rz, more space is created for holding the abrasion. The anti-frictional and dry running properties are drastically improved.

In the sense of DIN EN ISO 4287 “average maximum roughness value Rz” means the maximum roughness profile height. This is the sum of the height of the highest profile peak Rp and the depth of the greatest profile valley Rv of the roughness profile within a single measuring length.

[image]

As vertical distance from the utmost to the deepest profile point, Rz is a unit of measure for the scattering range of the roughness ordinate values. Rz is calculated as the arithmetic average from the maximum profile height of 5 single measuring lengths lr in the roughness profile.

The recesses suggested by the invention are not recesses which were created by chance when the diamond layer was made. These are recesses which are manufactured reproducibly, preferably in a specified arrangement. The recesses can be incorporated in the diamond layer after the diamond layer is manufactured. However it is also possible that the recesses are incorporated in a surface of the substrate before the diamond layer is applied. The recesses provided by the invention clearly differ in their dimensions from the depressions, for example gaps, created between the diamond crystals. The recesses provided by the invention have a greater depth than the depressions.

It is useful that the average maximum roughness value Rz is in the range from 0.1 to 5.0 μm. Diamond layers with such an average maximum roughness value Rz are particularly suitable for the manufacture of sliding ring seals and sliding bearings. Diamond layers with such an average maximum roughness value Rz also do not show a particularly high amount of abrasion during dry running. In any case the abrasion is so slight that it can be retained in the recesses provided by the invention. It is useful that the recesses have a depth of 0.2 to 100 μm, preferably 0.5 to 50 μm. A surface of the recesses can be made of graphite. This simplifies removal of the abrasion contained in the recesses.

It is useful that the recesses have linear structures. The recesses can in particular be straight or crescent-shaped. It is useful that the linear structures run slanted or crosswise to a sliding direction. As defined in a further arrangement the recesses can open towards the edge of the diamond layer so that the collected abrasion can be removed. Removal of the abrasion at the edge of the diamond layer further increases the anti-frictional and dry running properties of the gliding element.

A width of the recesses can be between 0.5 μm and 10 mm. Further it has been shown to be useful that the recesses have a net-like pattern or are also trough-like.

It is advantageous that a portion of 1 to 95% of the surface of the diamond layer is formed by the recesses. The recesses can thus also form an essential portion of the surface. A tribologically stressed contact surface of the diamond layer consists in this case only of single, preferably regularly spaced, islands.

According to a further embodiment the substrate is made from a ceramic, preferably SiC, or from a metal or a metal-ceramic composite material.

To make a gliding element as provided by the invention a method can be performed with the following steps according to a first version:

Apply a diamond layer with an average maximum roughness value Rz to a surface of the substrate and Make recesses in the diamond layer such that a depth of the recesses is greater than the average maximum roughness value Rz.

According to a second version a method with the following steps is provided for the making of a gliding element as defined in the invention:

Make recesses of a specified depth in the surface of the substrate and

Apply a diamond layer to the surface such that an average maximum roughness value Rz of the diamond layer is less than the depth of the recesses.

The suggested method is relatively simple to execute.

The diamond layer is usefully applied via a CVD method to the surface. Such methods are known according to the state of technology and are described in literature, for example, in K. Bachmann, W. van Enckewort, “Diamond Deposition Technologies” in Diamond and Related Materials (1), 1992, S. 1021-1034.

The recesses can be made mechanically by etching or via LASER. They can also be made by smoothing the diamond elevations created during the making of the diamond layer. Such diamond elevations protrude out from the diamond layer. By smoothing, these elevations are removed and broken off. The smoothing can be done by lapping.

According to a further particularly advantageous embodiment the surface of the recesses can be converted to graphite thermally, preferably during manufacturing via LASER. In particular with a linear embodiment of the recesses which open towards the edge of the diamond layer a graphite layer in the recesses makes it easier to remove the abrasion.

For the further advantageous embodiments of the method, reference is made to the embodiments described for the gliding element. These also apply accordingly to the method.

Based on the drawings, advantageous embodiments of the inventions will now be described in more detail. The figures are listed below:

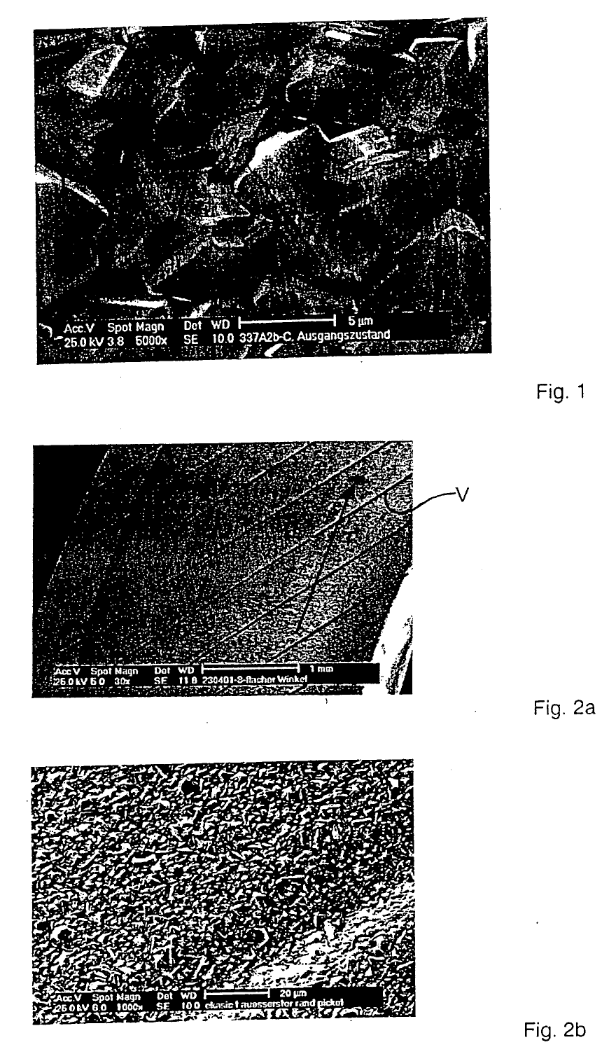

FIG. 1 A scanning electron microscope (REM) image of a diamond layer according to the state of art,

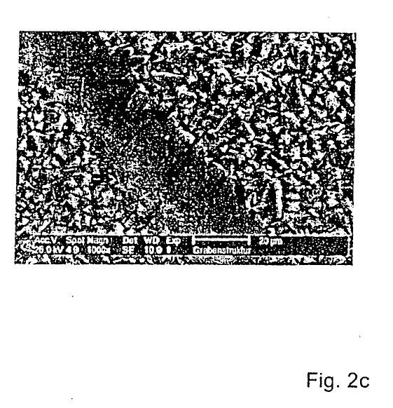

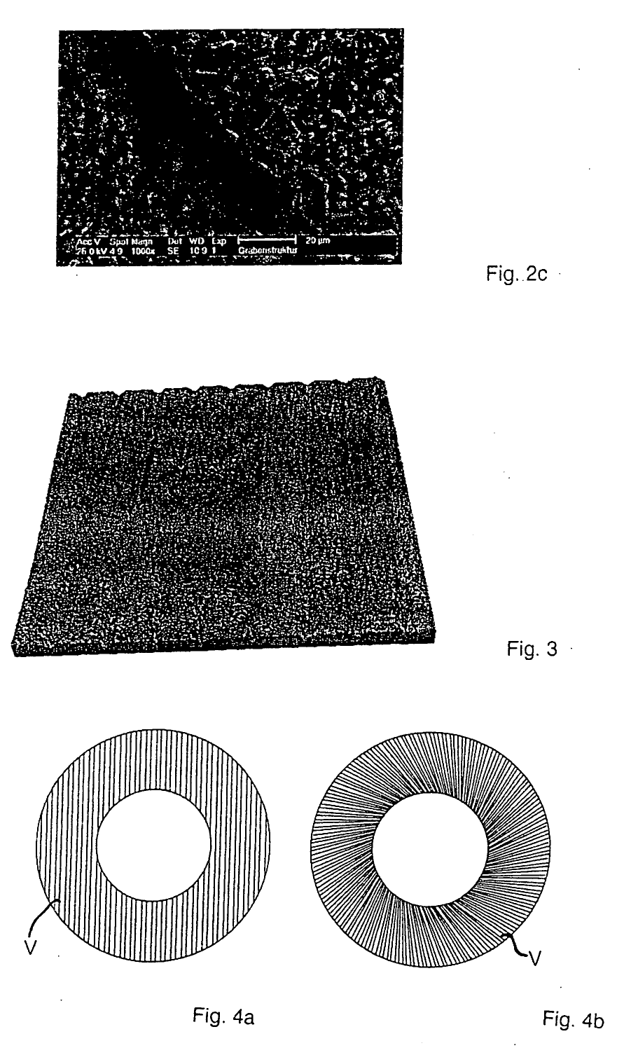

FIG. 2a-c REM images of the diamond layers according to the invention in different enlargements,

FIG. 3 A presentation in perspective of a diamond layer according to the invention,

FIG. 4a, b Schematic presentations of different recess patterns,

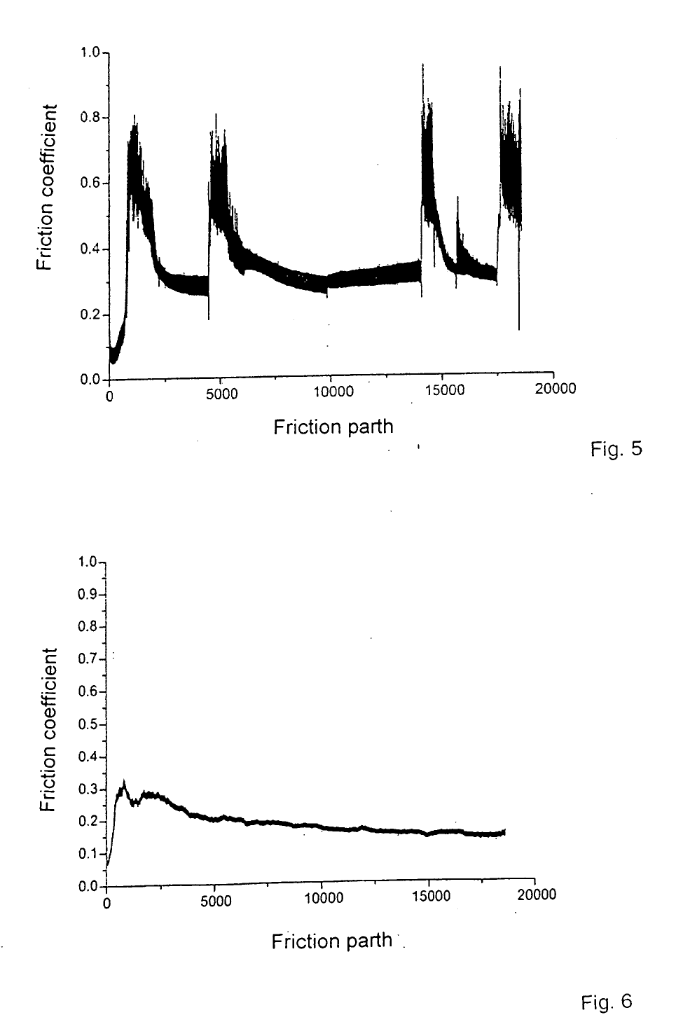

FIG. 5 The result of a dry running test using a conventional diamond layer,

FIG. 6 The result of a dry running test using a diamond layer according to the invention,

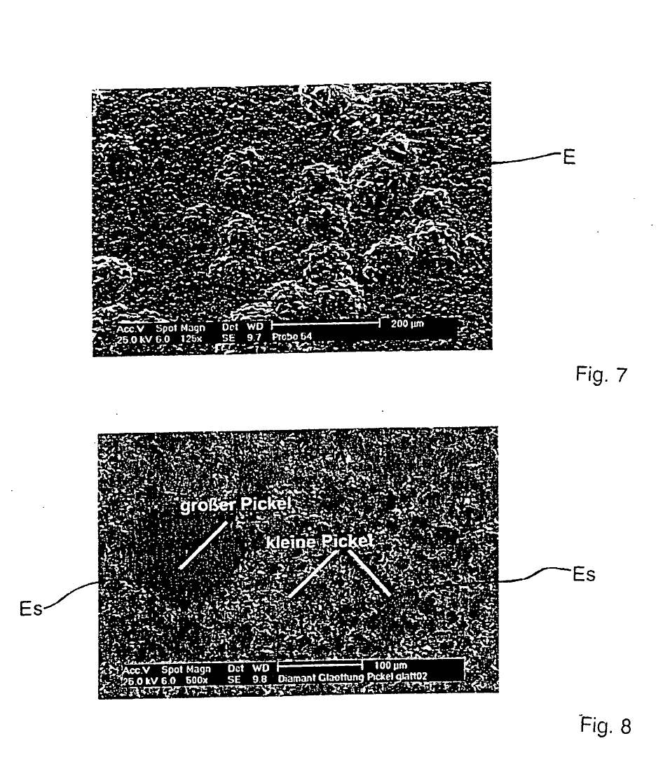

FIG. 7 A REM image of a conventional diamond layer with diamond elevations,

FIG. 8 A REM image of a further diamond layer according to the invention,

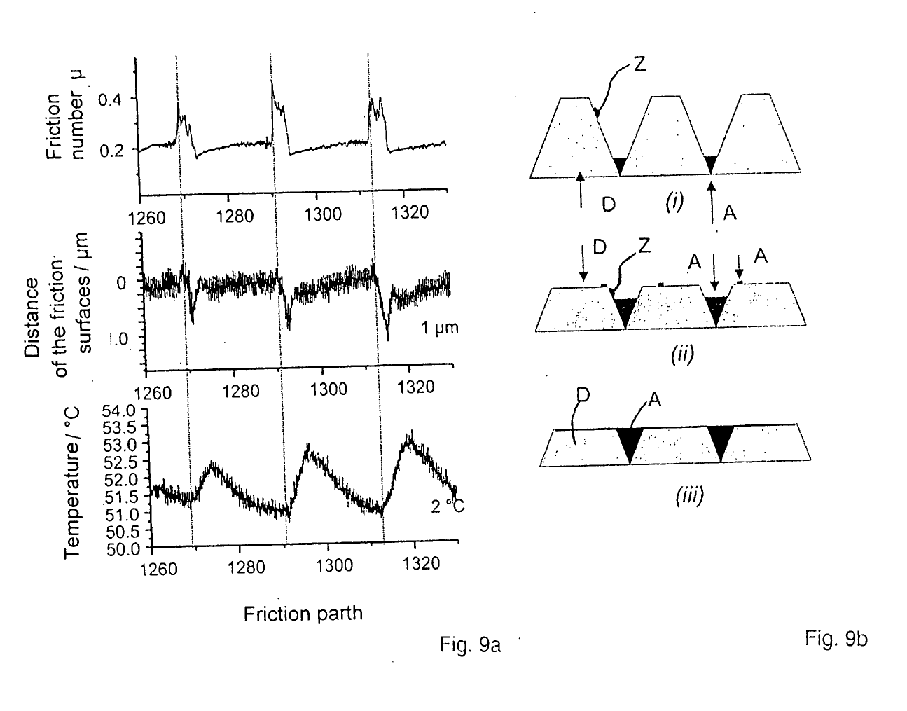

FIG. 9a Results of different measurements during dry running and

FIG. 9b A schematic presentation of the processes taking place during dry running.

FIG. 1 shows a REM image of a surface of a conventional diamond layer which has been deposited via a CVD method on a substrate, for example SiC. The topography of the surface is characterised by the {111} and {100} areas of the diamond crystals. Depressions are located between the diamond crystals. The average maximum roughness value Rz of the shown conventional diamond layer is 1.1.

FIG. 2a to FIG. 2c show REM images in various enlargements of a diamond layer according to the invention. Also here the diamond layer has an average maximum roughness value Rz of 1.1. Moreover linear recesses V are provided running at a slant to a sliding direction labelled T which recesses extend over the entire width of the diamond layer. The recesses V are arranged at regular intervals; they form parallel lines with a constant distance. FIG. 3 again shows in perspective the formation of the diamond layer.

It is useful that the thickness of the diamond layer for the gliding elements according to the invention is between 0.1 μm and 50 μm, preferably 1 to 20 μm. With this a diamond layer with a <111> texture setting is preferred. For an explanation, reference is made to DE 100 27 427.7 whose disclosed contents are included herewith. In addition a texture of <110> can also be set. With the design example shown in FIG. 2 and FIG. 3 the layer thickness of the diamond layer is 12 μm. The width of the linear recesses V is approximately 20 μm and the depth of the recesses V is approximately 5 μm. With this design example the depth of the recesses V is thus approximately 4.5 times the average maximum roughness value Rz. In general it has proved to be useful that the depth of the recesses V is greater than twice, preferably greater than 3 times and, particularly preferably, greater than 4 times the average maximum roughness value Rz.

FIGS. 4a and b show a sliding ring with a diamond layer. Also here linear recesses V are provided in turn on the diamond layer. With the sliding ring shown in FIG. 4a the recesses V are arranged parallel to each other at regular intervals. With the sliding ring shown in FIG. 4b the recesses run from an inner circumferential surface to an outer circumferential surface slanted towards the radial direction.

FIGS. 5 and 6 show the results of the dry running test in comparison. The particular friction coefficient is entered over the friction path. The results shown in FIG. 5 were obtained using sliding rings which are coated with a diamond layer as they are shown in FIG. 1 for example. The results shown in FIG. 6 were obtained using sliding rings which are coated with a diamond layer as provided by the invention which layer is shown in FIG. 2 to 4 for example. With the measurements the surface pressure is 0.2 N/mm², the rotation speed is 1.3 m/s and the run time is 4 hours. It is shown that the gliding elements coated with the diamond layers according to the invention have drastically better dry running properties. The diamond layer is still completely intact after a test time of 4 hours. No layer chipping at all can be observed.

FIG. 7 shows a REM image of a conventional diamond layer made by a CVD method. Such diamond layers often have elevations E. Such elevations E are usually not desired. According to the subject of this invention, diamond layers with such elevations E can nevertheless also be used to make gliding elements as provided by the invention.

FIG. 8 shows a REM image of a diamond layer of a gliding element as provided by the invention. The layer is made by removing the elevations E shown in FIG. 7 via lapping, for example. Elevation stubs Es remain. In this sample design a tribologically stressed surface is formed only by the sum of the elevation stubs Es protruding out over the surface of the diamond layer. The abrasion that occurs during operation can be deposited here around the elevation stubs Es. Naturally the elevation stubs Es shown in FIG. 8 can also be combined with the recesses shown in FIG. 2 to 4 for example. In this case the suggested gliding elements have excellent running in properties. The relatively high wear which occurs during running in causes the elevation stubs in particular to wear down. The abrasion is transported during run-in to the recesses V. With this the surface of the diamond layer is hardly damaged since the elevation stubs Es rise above this. After running in, the elevation stubs Es are essentially worn off. The wear caused by the running in is partially contained in the recesses. The diamond layer is hardly worn by the running in. It has a particularly long life. In addition the differences in layer thickness created by the deposit of the diamond layer can be equalised by the elevation stubs Es.

FIG. 9a shows various measuring results on the friction path. This involves the temperature in ° C., the distance of the friction surface in μm and the friction number μ. The results show the effects of an abrasion incorporated between the friction surfaces. If the abrasion gets between the friction surfaces, the temperature increases and the distance of the friction surfaces increases. At the same time the friction number jumps up suddenly.

FIG. 9b shows schematically the development of a conventional diamond layer during dry running. First the crystal points of the diamond crystal D (FIG. 9b (i)) break. The abrasion A created by this penetrates between the depressions Z created between the diamond crystals (see FIG. 9b (ii)). As soon as the depressions Z are completely filled with abrasion A (see FIG. 9b (iii)), the abrasion A is moved to the surface. After a short time catastrophical wear occurs, in particular the diamond layer chips off thus causing the gliding element to fail.

The manufacture of the gliding elements as provided by the invention can always be performed in two ways. According to the first method a substrate, made of SiC for example, is first provided. Recesses V are then incorporated into the substrate in the conventional way. This can be done by mechanical removal with diamond-coated tools. Removal is also possible via conventional LASER. In any case recesses V are incorporated into the surface of the substrate in a specified arrangement. With recesses V this can be ditch-like structures or troughs. The recesses V usefully form a specified regular pattern. They have a depth of 2 to 10 μm and a diameter or a width of 8 to 30 μm. The thus prepared substrate is then coated via the conventional CVD method. The layer thickness of the applied diamond layer is 8 to 10 μm. The parameters are set so that the recesses V incorporated into the substrate before are imaged by the diamond layer.

According to a second method the recesses V are also first made after the application of the diamond layer. For this purpose the recesses are also mechanically worked into the surface of the diamond layer, for example with saws or preferably via laser processing. With laser processing a conversion of the processed surfaces into graphite takes place. This creates particularly smooth recesses through which the abrasion can easily be transported away.

### REFERENCE DESIGNATION LIST

T Transport direction of the abrasion
V Recess
E Elevation
Es Elevation stub
D Diamond crystal
Z Gap
A Abrasion

1. Gliding element with a substrate and a diamond layer formed on a surface of the substrate with an average maximum roughness value Rz,
characterised thereby that
the diamond layer has reproducible recesses (V) for the holding of abrasion (A) wherein a depth of the recesses (V) is greater than the average maximum roughness value Rz.

2. Gliding element as defined in claim 1, wherein the average maximum roughness value Rz is in the range from 0.1 to 5.0 μm.

3. Gliding element as defined in claim 1, wherein the recesses (V) have a depth of 0.2 to 100 μm.

4. Gliding element as described in claim 1, wherein a surface of the recesses (V) is formed from graphite.

5. Gliding element as defined in claim 1, wherein the recesses (V) have linear structures.

6. Gliding element as defined in claim 1, wherein the linear structures run at one of: a slant and crosswise to a sliding direction (T).

7. Gliding element as defined in claim 1, wherein the recesses (V) open towards the edge of the diamond layer so that the abrasion (A) collected therein can be removed.

8. Gliding element as defined in claim 1, wherein a width of the recesses (V) is between 0.6 μm and 10 mm.

9. Gliding element as defined in claim 1, wherein the recesses (V) form a net-like pattern.

10. Gliding element as defined in claim 1, wherein the recesses (V) have a trough-like form.

11. Gliding element as defined in claim 1, wherein a portion of from 1 to 95% of the surface of the diamond layer is formed by the recesses (V).

12. Gliding element as defined in claim 1, wherein the substrate is made from one of: a ceramic, SiC, a metal and a metal-ceramic composite material.

13. Method for the manufacture of a gliding element comprising the following steps:
applying a diamond layer with an average maximum roughness value Rz to a surface of a substrate and
manufacturing recesses (V) on the diamond layer such that a depth of the recesses (V) is greater than the average maximum roughness value Rz.

14. Method for the manufacture of a gliding element comprising the following steps:
manufacturing recesses (V) of a specified depth of a surface of a substrate and
applying a diamond layer on the surface such that an average maximum roughness value Rz of the diamond layer is smaller than the depth of the recesses (V).

15. Method as defined in claim 13, wherein the diamond layer is applied to the surface with a CVD method.

16. Method as defined in claim 13, wherein the recesses (V) are mechanically made by etching or via LASER.

17. Method as defined in claim 13, wherein the recesses are made by smoothing of the diamond elevations (E) created during the manufacture of the diamond layer.

18. Method as defined in claim 13, wherein the average maximum roughness value Rz is in the range from 0.1 to 5.0 μm.

19. Method as defined in claim 13, wherein the recesses (V) are made with a depth of 0.2 to 100 μm.

20. Method as defined in claim 13, wherein a surface of the recesses (V) is thermally converted to graphite, preferably during the manufacture via LASER.

21. Method as defined in claim 13, wherein the recesses (V) are formed as linear structures.

22. Method as defined in claim 13, wherein the linear structures run at one of: a slant and crosswise to a sliding direction (T).

23. Method as defined in claim 13, wherein the recesses (V) are manufactured open towards the edge of the diamond layer so that the abrasion (A) collected therein can be transported away.

24. Method as defined in claim 13, wherein the linear structures are manufactured between 0.5 μm and 10 mm.

25. Method as defined in claim 13, wherein the recesses (V) are formed as a net-like pattern.

26. Method as defined in claim 13, wherein the recesses (V) have a trough-like form.

27. Method as defined in claim 13, wherein a portion from 1 to 95% of the surface of the diamond layer is formed by the recesses (V).

28. Method as defined in claim 13, wherein the substrate is made of one of: a ceramic, SiC, a metal or a metal-ceramic composite material.
